(19) United States
(12) Patent Application Publication
(10) Pub. No.: US 2025/0196243 A1
(43) Pub. Date: Jun. 19, 2025

(54) ELECTRICAL DISCHARGE MACHINING EQUIPMENT AND METHOD WITH EQUAL-ENERGY DENSITY

(71) Applicants: NATIONAL TAIWAN NORMAL UNIVERSITY, Taipei (TW); ACCUTEX TECHNOLOGIES CO., LTD., Taichung (TW)

(72) Inventors: Shun-Tong Chen, Taipei (TW); En-Ruei Jhang, Taipei (TW); Guan-Wei Chen, Taipei (TW); Hua-Yu Tseng, Taichung (TW); Chen-Fu Tsai, Taichung (TW)

(21) Appl. No.: 18/599,323

(22) Filed: Mar. 8, 2024

(30) Foreign Application Priority Data
Dec. 14, 2023 (TW) 112148828

(51) Int. Cl. B23H 7/20

(52) U.S. Cl. CPC B23H 7/20; B23H 2600/12

(57) ABSTRACT

An electrical discharge machining equipment with equal-energy density comprises an electrode, a parameter database, a signal capturing device and a controller. The parameter database stores an equal-energy density sheet comprising a plurality of processing parameter sets. Each processing parameter set is corresponding to a material removed volume and comprises a discharge energy, a discharge parameter, a feed rate and an energy density. The signal capturing device detects a first discharge parameter of the electrode during machining a work piece. The controller selects a first feed rate to control the electrode. When the first discharge parameter changes to a second discharge parameter, the controller calculates a material volume of the workpiece according to the second discharge parameter and the equal-energy density sheet, and selects a second feed rate according to the material volume, the material removed volume and the equal-energy density sheet to control the electrode for processing the workpiece.

### BACKGROUND OF THE INVENTION

### 1. Field of the Invention

The present invention relates to the field of electrolytic machining, and more particularly, to an electrical discharge machining equipment with equal-energy density and method that maintains equal energy density processing and automatically adjusts the feed rate.

### 2. Description of the Prior Art

In recent years, with the advancement of semiconductor, electronic and mechanical technologies, products have been developing in the direction of miniaturization and refinement. In the aerospace, automotive, medical and electronic fields, the miniature products are usually manufactured by high precision molds. Usually, most of the materials used for high precision molds are chosen for their high hardness and strength, such as SKD-11. Due to the high mechanical strength and complex design structure of the high precision molds, the high precision molds are usually processed by CNC wire-cutting electrical discharge machines.

In the common machining process, the workpieces or molds are usually firstly rough cut to remove a large amount of unnecessary materials, and then the workpieces are trimmed to the target design structure by finish machining. However, in the existing technology, the finish machining mainly relies on experienced technicians to manually adjust the processing parameters by fine-tuning the process several times, which not only increases the labor cost and processing time cost but also reduces the processing efficiency. Moreover, the discharge energy and the feed rate of the electrode are still selected manually, which can lead to different processing degree of the electrode, so as to reduce the processing stability and the processing quality.

Therefore, it is necessary to develop a new type of discharge processing equipment to solve the problems of the prior art.

### SUMMARY OF THE INVENTION

In view of this, one scope of the present invention is to provide an electrical discharge machining equipment with equal-energy density. In the present embodiment, the electrical discharge machining equipment with equal-energy density comprises an electrode, a processing parameter database, a signal capturing device and a controller. The electrode is configured to process a workpiece. The processing parameter database is configured to store an equal-energy density sheet. The equal-energy density sheet comprises a plurality of processing parameter sets. Each of the processing parameter sets is corresponding to a material removed volume and comprises a discharge energy, a discharge parameter, a feed rate and an energy density. The energy density is generated according to a calculation of the discharge energy and the material removed volume, and the processing parameter sets having the same energy density. The signal capturing device is configured to detect and capture a first discharge parameter of the electrode during machining the workpiece. The controller is connected to the electrode, the processing parameter database and the signal capturing device. The controller is configured to select a first feed rate of a first processing parameter set to control the electrode for processing the workpiece according to the first discharge parameter and the equal-energy density sheet. When the signal capturing device detects that the first discharge parameter changes to a second discharge parameter, the controller calculates a material volume of the workpiece according to the second discharge parameter and the equal-energy density sheet, and selects a second feed rate from a second processing parameter set according to the material volume, the material removed volume and the equal-energy density sheet and controls the electrode to process the workpiece according to the second feed rate.

Wherein, the electrical discharge machining equipment with equal-energy density further comprises an analysis unit connected to the processing parameter database, and the processing parameter database is configured to store a plurality of historical processing parameters. The analysis unit is configured to analyze the plurality of historical processing parameters to generate the equal-energy density sheet with a regression analysis.

Wherein, the historical processing parameters comprise at least one of a normal discharge frequency, an arc discharge frequency, a short-circuit discharge frequency, a processing time, a processing coordinate, a processing voltage, a processing current, a processing volume and an electrode feed rate.

Wherein, the first discharge parameter is corresponding to a first discharge energy and the second discharge parameter is corresponding to a second discharge energy, and the controller calculates the material volume according to the first discharge energy, the second discharge energy, the material removed volume corresponding to the first discharge energy and the energy density.

Another scope of the present invention is to provide an electrical discharge machining method with equal-energy density. In the present embodiment, the electrical discharge machining method with equal-energy density comprises the following steps of: an electrode processing a workpiece with a first discharge energy, a first discharge parameter and a first feed rate of a first processing parameter set; a signal capturing device detecting that the first discharge parameter changes to a second discharge parameter; a controller calculating a material volume of the workpiece according to the second discharge parameter and an equal-energy density sheet; and the controller selecting a second feed rate from a second processing parameter set according to the material volume, the material removed volume and the equal-energy density sheet and controlling the electrode to process the workpiece according to the second feed rate. Wherein, the equal-energy density sheet comprises a plurality of processing parameter sets. Each of the processing parameter sets is corresponding to a material removed volume and comprises a discharge energy, a discharge parameter, a feed rate and an energy density. The energy density is generated according to a calculation of the discharge energy and the material removed volume, and the processing parameter sets have the same energy density.

Wherein, the electrical discharge machining method with equal-energy density further comprises the following steps of: an analysis unit analyzing a plurality of historical processing parameters to generate the equal-energy density sheet with a regression analysis.

Wherein, the first discharge parameter is corresponding to a first discharge energy and the second discharge parameter is corresponding to a second discharge energy. And, the step of the controller calculating the material volume of the workpiece according to the second discharge parameter and the equal-energy density sheet further comprises the following steps of: the controller calculating the material volume according to the first discharge energy, the second discharge energy, the material removed volume corresponding to the first discharge energy and the energy density.

Wherein, the electrical discharge machining method with equal-energy density further comprises the following steps of: the electrode roughly cutting the workpiece.

In summary, the electrical discharge machining equipment with equal-energy density of the present invention can detect the processing parameters of the electrodes through the signal capturing device and the equal-energy density sheet and adjust the feed rate automatically, so as to achieve the “cut one and repair one”. Moreover, it is possible to eliminate the need for labor and experience to make multiple finishing adjustments, so as to reduce the processing cost and improve the processing efficiency. In addition, the electrical discharge machining equipment with equal-energy density of the present invention can maintain the electrodes at an equal-energy density through the equal-energy density sheet, so as to improve the stability and processing quality.

### BRIEF DESCRIPTION OF THE APPENDED DRAWINGS

FIG. 1 is a function block diagram illustrating an electrical discharge machining equipment with equal-energy density according to an embodiment of the present invention.

FIG. 2 is a structural schematic diagram illustrating an electrode and a workpiece according to an embodiment of the present invention.

FIG. 3A, FIG. 3B and FIG. 3C are schematic diagrams illustrating an electrode machining the workpiece according to an embodiment of the present invention, respectively.

FIG. 4 is a flowchart diagram illustrating an electrical discharge machining method with equal-energy density according to an embodiment of the present invention.

FIG. 5 is a flowchart diagram illustrating an electrical discharge machining method with equal-energy density according to an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of this specification, the description with reference to the terms “an embodiment”, “another embodiment” or “part of an embodiment” means that a particular feature, structure, material or characteristic described in connection with the embodiment including in at least one embodiment of the present invention. In this specification, the schematic representations of the above terms do not necessarily refer to the same embodiment. Furthermore, the particular features, structures, materials or characteristics described may be combined in any suitable manner in one or more embodiments. Furthermore, the indefinite articles “a” and “an” preceding a device or element of the present invention are not limiting on the quantitative requirement (the number of occurrences) of the device or element. Thus, “a” should be read to include one or at least one, and a device or element in the singular also includes the plural unless the number clearly refers to the singular.

The electrical discharge machining equipment with equal-energy density of the present invention can be applied in the precision or finishing stage, not only in the second finishing process after the first rough cutting of the workpiece, but also in the precision process with high accuracy.

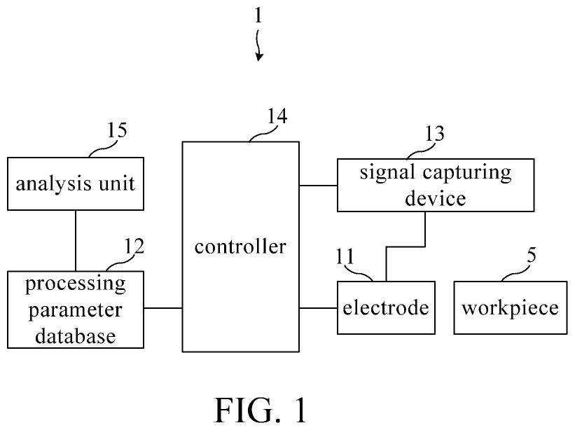

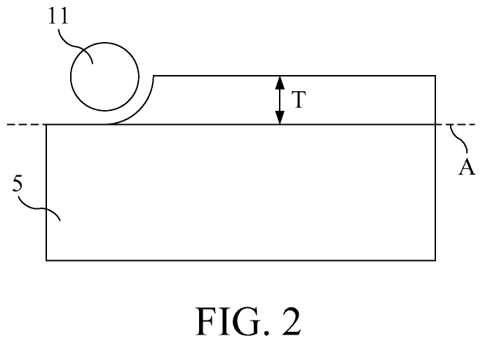

Please refer to FIG. 1 and FIG. 2. FIG. 1 is a function block diagram illustrating an electrical discharge machining equipment 1 with equal-energy density according to an embodiment of the present invention. FIG. 2 is a structural schematic diagram illustrating an electrode 11 and a workpiece 5 according to an embodiment of the present invention. As shown in FIG. 1, the electrical discharge machining equipment 1 with equal-energy density comprises an electrode 11, a processing parameter database 12, a signal capturing device 13 and a controller 14. The signal capturing device 13 is connected to the electrode 11, and the controller 14 is connected to the electrode 11, the processing parameter database 12 and the signal capturing device 13.

In this embodiment, the electrode 11 is configured to process a workpiece 5. In practice, the electrode 11 and the workpiece 5 can be connected to the power sources of different polarities and the electrodes 11 can be moved on the surface of the workpiece 5. A discharge gap is between the electrode 11 and the workpiece 5. When the electrode 11 is moved toward the workpiece 5 and moved to the discharge gap, the electrode 11 is discharged to create a spark between the electrode 11 and the workpiece 5. At the same time, the high temperatures generated by the spark will melt the workpiece 5, so as to achieve discharge processing. Furthermore, the electrode 11 can be wire electrodes and can be moved continuously (e.g., with a wire feeder and wire winder) to process the workpiece 5. The material of the electrode 11 can be brass, but is not limited the aforementioned. In practice, as shown in FIG. 2, after the workpiece 5 is rough machined, the surface of the workpiece 5 will contain a rough-cut residue T. The electrode 11 can be moved in the direction of the finishing target line A to remove the rough-cut residue T for further finishing.

In this embodiment, the processing parameter database 12 is configured to store an equal-energy density sheet. The equal-energy density sheet comprises a plurality of processing parameter sets. Each of the processing parameter sets are corresponding to a material removed volume and comprises a discharge energy, a discharge parameter, a feed rate and an energy density. In practice, the discharge energy (E) is the energy generated during the processing of the electrode 11 and is the product of an operating voltage (Ve), an average processing current (IA), the discharge time (τₒₙ), and the discharge frequency (f), as shown in formula (1). The discharge parameter can be the discharge frequency (f) in the discharge energy (E), and can be a normal discharge frequency (Norm), an arc discharge frequency (Arc) or a short circuit discharge frequency (Shrt). The material removed volume is a rough-cut residue volume (Vol) that can be removed by the electrode 11 at a feed rate (F) and a machining time (S) as shown in formulas (2), (3) and (4). Wherein, L is the machining length and H is the width of the workpiece. The energy density (Ed) is the amount of discharge energy required to process a unit of the material removed volume, as shown in formula (5).

$$E = Ve \times {I}_{A} \times {τ}_{on} \times f \qquad ( 1 )$$

$$Vol = L \times H \times T \qquad ( 2 )$$

$$L = F \times S \qquad ( 3 )$$

$$S = {τ}_{on} \times f \qquad ( 4 )$$

$$Ed = E / Vol \qquad ( 5 )$$

In this embodiment, all processing parameter sets of the equal-energy density sheet have the same energy density, i.e., all processing parameter sets are equal energy density. That is, when the electrode 11 removes a plurality of identical rough-cut residue volumes, the electrode 11 all applies the same discharge energy for processing, as shown in formula (6). Furthermore, when the electrode 11 removes a plurality of different rough-cut residue volumes, the electrode 11 applies a corresponding amount of discharging energy for processing under the condition of equal energy density, as shown in formula (7). In practice, the energy density can be generated according to the material properties of the electrode and the workpiece as well as a plurality of actual processing data, as explained in detail below.

$$Ed = {E}_{1} / {Vol}_{1} = … = {E}_{n} / {Vol}_{n} ’ n = 1 \qquad ( 6 )$$

$$Ed = {E}_{1} / {Vol}_{1} = {E}_{2} / {Vol}_{2} = {E}_{3} / {Vol}_{3} = … = {E}_{n} / {Vol}_{n} ’ n = 1 , 2 , 3 , \qquad ( 7 )$$

As shown in FIG. 1, in this embodiment, the electrical discharge machining equipment 1 with equal-energy density further comprises an analysis unit 15 connected to the processing parameter database 12, and the processing parameter database 12 is configured to store a plurality of historical processing parameter sets. Each of the historical processing parameter sets comprises a plurality of historical processing parameters. The historical processing parameters can comprise at least one of a discharge frequency, a normal discharge frequency, an arc discharge frequency, a short circuit discharge frequency, a processing time, a processing coordinate, a processing voltage, a processing current, a processing volume, and an electrode feed rate. In practice, the historical processing parameter sets can be actual processing parameters of the electrode 11 under a variety of different parameter conditions. For example, a number of processing parameter sets of the electrode machining the workpiece at the same discharge frequency and at a number of different feed rates; a number of processing parameter sets of the electrode machining the workpiece at the same feed rate and at a number of different discharge frequencies; and/or a number of processing parameter sets of the electrode machining the workpiece at a number of different discharge frequencies, operating voltages, and feed rates. Similarly, each of the historical processing parameter sets can be corresponding to a processing volume (i.e., the aforementioned material removed volume).

Furthermore, in this embodiment, the analysis unit 15 is configured to analyze the plurality of historical processing parameters to generate the equal-energy density sheet with a regression analysis. In practice, the analysis unit 15 can analyze all historical processing parameter sets by linear regression, multiple regression, logistic regression, nonlinear regression, log-linear regression, lasso regression, or ridge regression to find out the energy density of the electrodes 11 for processing the workpiece 5, and to find out the optimal processing parameter sets of the electrodes 11 for processing different material removed volumes under the same energy density, so as to build up the equal-energy density sheet.

In this embodiment, the signal capturing device 13 is configured to detect and capture the processing parameters of the electrode 11 during machining the workpiece 5. In practice, the signal capturing device 13 is electrically connected to the electrode 11. When the electrode 11 is machining, the signal capturing device 13 detects a discharge wave train of the discharge energy of the electrode 11 during machining, and captures a real-time processing parameters such as the aforementioned discharge frequency, normal discharge frequency, arc discharge frequency, short circuit discharge frequency, processing time, processing coordinate, processing voltage, processing current, electrode feed rate from the discharge wave train. Furthermore, the signal capturing device 13 can be connected to the processing parameter database 12. After the signal capturing device 13 captures the processing parameters of the electrode 11 during processing, the signal capturing device 13 can store the processing parameters in the processing parameter database 12.

In addition, the signal capturing device 13 can also capture the aforementioned historical processing parameter sets and the historical processing parameters, and store the data in the processing parameter database 12 for analysis by the analysis unit 15. In practice, the workpiece 5 can first be programmed with a known rough-cut residue, i.e. a known rough-cut residue volume is set. Next, the electrode 11 processes the workpiece 5 to remove the rough-cut residue volume, and the signal capturing device 13 instantly detects and captures the processing parameters of the electrode 11 processing as historical processing parameters. Finally, the analysis unit 15 analyzes the historical processing parameters to build up the equal-energy density sheet.

In this embodiment, the controller 14 is configured to control the processing of the electrodes 11 according to the equal-energy density sheet. In practice, the controller 14 can be a computer numerical control (CNC) controller and can select a processing parameter set from the equal-energy density sheet. The controller 14 can apply energy to the electrodes 11 according to the discharge energy and discharge parameters in the processing parameter set, and control the electrodes 11 to move according to the feed rate in the processing parameter set to machine the workpiece. In an embodiment, the controller can also be a signal controller and be connected the processing parameter database and a CNC controller. The controller can send each of the processing parameters in the processing parameter sets to the CNC controller, and then the CNC controller controls the electrode according to the processing parameters. The controller can also be integrated with the aforementioned analysis unit in the same chip.

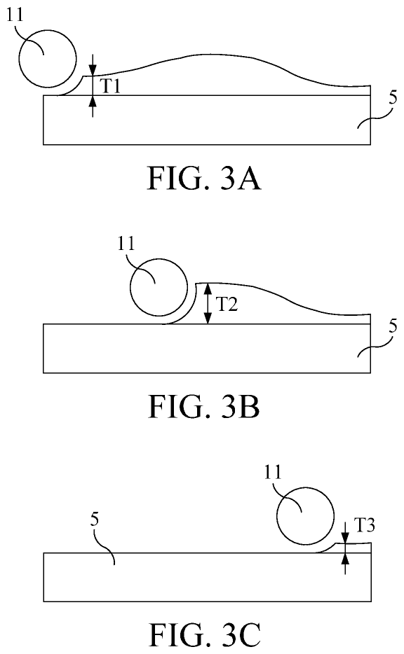

Please refer to FIG. 1, FIG. 3A, FIG. 3B and FIG. 3C. FIG. 3A, FIG. 3B and FIG. 3C are schematic diagrams illustrating an electrode 11 machining the workpiece 5 according to an embodiment of the present invention, respectively. FIG. 3A, FIG. 3B and FIG. 3C are schematic diagrams illustrating the machining of the same workpiece 5 by electrode 1 with different rough-cut residues. Wherein, the second rough-cut residue T2 of the workpiece 5 of FIG. 3B is larger than the first rough-cut residue T1 of the workpiece 5 of FIG. 3A, and the third rough-cut residue T3 of the workpiece 5 of FIG. 3C is smaller than the second rough-cut residue T2 of the workpiece 5 of FIG. 3B. As shown in FIG. 3A, when the electrical discharge machining equipment 1 with equal-energy density of the present invention is in operation, the controller 14 can firstly select a first processing parameter set from the equal-energy density sheet as an initial processing parameter to control the electrode 11. And, the electrode 11 can process the workpiece 5 according to the first discharge energy and the first feed rate in the first processing parameter set. In practice, the workpiece 5 can firstly be measured by a measuring device (not shown) to determine the value of the first rough-cut residue T at the initial processing position, and then calculate the first rough-cut residue volume of the workpiece 5 to be machined. The controller 14 can select a processing parameter set corresponding to the rough-cut residue volume that matches the first rough-cut residue volume from the equal-energy density sheet as the first processing parameter set according to the calculated the first rough-cut residue volume. While the controller 14 is controlling the electrodes 11 to process the workpiece 5 with the first processing parameter set, the signal capturing device 13 is also detecting the first discharge frequency f1 (i.e., the aforementioned first discharge parameter) of the first discharge energy.

As shown in FIG. 3B, when the electrode 11 moves from the position of the first rough-cut residue T1 to the position of the second rough-cut residue T2, the second rough-cut residue T2 is larger than the first rough-cut residue T1, so the machining area between the electrode 11 and the workpiece 5 becomes larger. That is, the area of the discharge gap between the electrode 11 and the workpiece 5 becomes larger. Therefore, the electrode 11 releases the second discharge energy larger than the first discharge energy to process the workpiece 5. At this time, the second discharge frequency f2 of the second discharge energy is larger than the first discharge frequency f1 of the first discharge energy. When the signal capturing device 13 detects and captures that the electrodes 11 change from the first discharge frequency f1 to the second discharge frequency f2, the controller 14 will calculate the second discharge energy according to the second discharge frequency f2. Base on the aforementioned formula (7), the controller can calculate the material volume corresponding to the second discharge energy (i.e., the second rough-cut residue volume) according to the energy density, the first discharge energy, the first rough-cut residue volume (i.e., the material removed volume corresponding to the first discharge energy) and the second discharge energy. Next, the controller 14 selects a processing parameter set corresponding to the material removed volume that matches the material volume from the equal-energy density sheet according to the material volume as a second processing parameter set. In addition, the controller 14 controls the electrodes 11 to process the workpiece 5 with the second feed rate according to the second processing parameter set, so that the electrodes 11 are able to maintain the equal energy density for processing.

As shown in FIG. 3C, when the electrode 11 moves from the position of the second rough-cut residue T2 to the position of the third rough-cut residue T3, the third rough-cut residue T3 is smaller than the second rough-cut residue T2, so the machining area between the electrode 11 and the workpiece 5 becomes larger. Therefore, the electrode 11 releases the third discharge energy smaller than the second discharge energy to process the workpiece 5. At this time, the third discharge frequency f3 of the third discharge energy is smaller than the second discharge frequency f2 of the second discharge energy. When the signal capturing device 13 detects and captures that the electrodes 11 change from the second discharge frequency f2 to the third discharge frequency f3, the controller 14 will calculate the third discharge energy according to the third discharge frequency f3. Similarly, base on the aforementioned formula (7), the controller can calculate the material volume corresponding to the third discharge energy (i.e., the third rough-cut residue volume) according to the energy density, the second discharge energy, the second rough-cut residue volume and the third discharge energy. Next, the controller 14 selects a third processing parameter set from the equal-energy density sheet according to the third material removed volume. In addition, the controller 14 controls the electrodes 11 to process the workpiece 5 with the third feed rate according to the third processing parameter set.

Therefore, the electrical discharge machining equipment with equal-energy density of the present invention can detect the processing parameters of the electrode through the signal capturing device and the equal-energy density sheet in real time and adjust the feed rate automatically without manual adjustment, so as to reduce the processing cost and improve the processing efficiency. In addition, the electrical discharge machining equipment with equal-energy density of the present invention can maintain the electrode at equal energy density through the equal-energy density sheet for finishing, so as to improve stability and processing quality.

The controller selects the first processing parameter set in a manner that can be other than the aforementioned patterns. In an embodiment, the controller can firstly and randomly select a processing parameter set from an equal-energy density sheet as the initial processing parameter to control the electrode, and the signal capturing device simultaneously detects the discharge frequency of the discharge energy of the processing parameter set. When the signal capturing device detects a change in the discharge frequency, the controller calculates a material volume of the current rough-cut residue according to the energy density, the processing parameter set and the changed discharge frequency. Finally, the controller selects the corresponding processing parameter set from the equal-energy density sheet according to the current material volume and controls the electrode, so the electrode can be processed with the equal-energy density and at the correct feed rate.

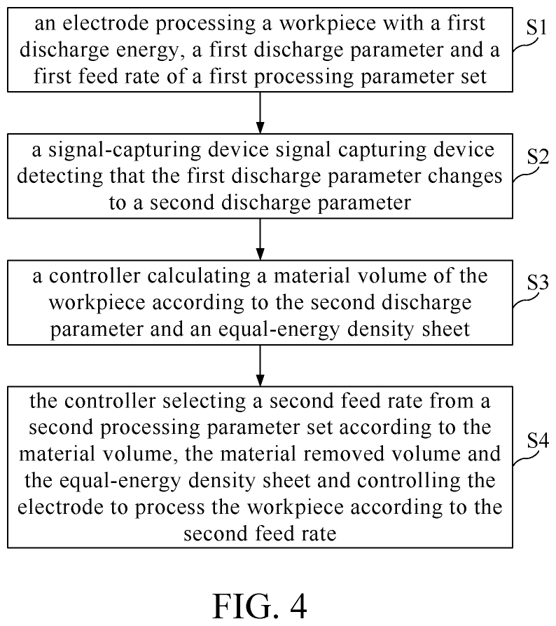

Please refer to FIG. 1 and FIG. 4. FIG. 4 is a flowchart diagram illustrating an electrical discharge machining method with equal-energy density according to an embodiment of the present invention. The steps of the electrical discharge machining method with equal-energy density of FIG. 4 can be achieved by the electrical discharge machining equipment 1 with equal-energy density of FIG. 1. As shown in FIG. 4, in this embodiment, the electrical discharge machining method with equal-energy density comprises the following steps: step S1: an electrode 11 processing a workpiece 5 with a first discharge energy, a first discharge parameter and a first feed rate of a first processing parameter set; step S2: a signal capturing device 13 detecting that the first discharge parameter changes to a second discharge parameter; step S3: a controller 14 calculating a material volume of the workpiece 5 according to the second discharge parameter and an equal-energy density sheet; and step S4: the controller 14 selecting a second feed rate from a second processing parameter set according to the material volume, the material removed volume and the equal-energy density sheet and controlling the electrode 11 to process the workpiece 5 according to the second feed rate. Wherein, the equal-energy density sheet comprises a plurality of processing parameter sets. Each of the processing parameter sets is corresponding to a material removed volume and comprises a discharge energy, a discharge parameter, a feed rate and an energy density. The energy density is generated according to a calculation of the discharge energy and the material removed volume, and the processing parameter sets have the same energy density.

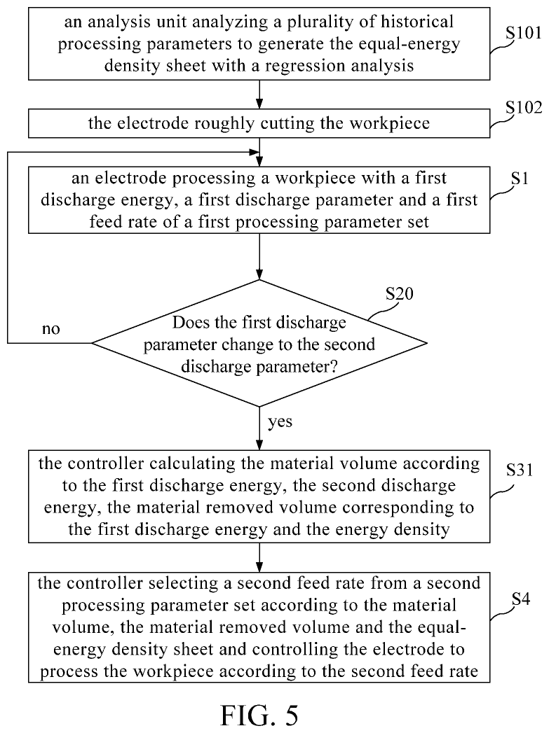

Please refer to FIG. 1 and FIG. 5. FIG. 5 is a flowchart diagram illustrating an electrical discharge machining method with equal-energy density according to an embodiment of the present invention. The steps of the electrical discharge machining method with equal-energy density of FIG. 5 can be achieved by the electrical discharge machining equipment 1 with equal-energy density of FIG. 1 and FIG. 5 shows further steps. As shown in FIG. 5, in this embodiment, the electrical discharge machining method with equal-energy density further comprises the following steps: step S101: an analysis unit 15 analyzing a plurality of historical processing parameters to generate the equal-energy density sheet with a regression analysis; step S102: the electrode 11 roughly cutting the workpiece 5. Step S1: an electrode 11 processing a workpiece 5 with a first discharge energy, a first discharge parameter and a first feed rate of a first processing parameter set; step S20: the signal capturing device 13 determining whether the first discharge parameter of the electrode 11 is changed to a second discharge parameter. If the determination result is no, go back to perform step S1. If the determination result is yes, perform step S31: the controller 14 calculating the material volume according to the first discharge energy, the second discharge energy, the material removed volume corresponding to the first discharge energy and the energy density; step S4: the controller 14 selecting a second feed rate from a second processing parameter set according to the material volume, the material removed volume and the equal-energy density sheet and controlling the electrode 11 to process the workpiece 5 according to the second feed rate.

In practice, the rough cutting process of step S102 can be performed before the finishing process of step S1. The step S102 of establishing an equal-energy density sheet can be performed before the step of discharge machining. In addition, in step S20, when the determination result is no, it means that the discharge energy of the electrode 11 is maintained as the first discharge parameter. That is, the rough-cut residue of the workpiece remains unchanged, and the electrode 11 is still processed with the processing parameters of the first processing parameter set.

In summary, the electrical discharge machining equipment with equal-energy density of the present invention can detect the processing parameters of the electrodes through the signal capturing device and the equal-energy density sheet and adjust the feed rate automatically, so as to achieve the “cut one and repair one”. Moreover, it is possible to eliminate the need for labor and experience to make multiple finishing adjustments, so as to reduce the processing cost and improve the processing efficiency. In addition, the electrical discharge machining equipment with equal-energy density of the present invention can maintain the electrodes at an equal-energy density through the equal-energy density sheet, so as to improve the stability and processing quality.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electrical discharge machining equipment with equal-energy density, comprising:
an electrode, configured to process a workpiece;
a processing parameter database, configured to store an equal-energy density sheet, the equal-energy density sheet comprising a plurality of processing parameter sets, each of the processing parameter sets being corresponding to a material removed volume and comprising a discharge energy, a discharge parameter, a feed rate and an energy density, the energy density being generated according to a calculation of the discharge energy and the material removed volume, and the processing parameter sets having the same energy density;
a signal capturing device, configured to detect and capture a first discharge parameter of the electrode during machining the workpiece; and
a controller connected to the electrode, the processing parameter database and the signal capturing device, the controller being configured to select a first feed rate of a first processing parameter set to control the electrode for processing the workpiece according to the first discharge parameter and the equal-energy density sheet;
wherein, when the signal capturing device detects that the first discharge parameter changes to a second discharge parameter, the controller calculates a material volume of the workpiece according to the second discharge parameter and the equal-energy density sheet, and selects a second feed rate from a second processing parameter set according to the material volume, the material removed volume and the equal-energy density sheet and controls the electrode to process the workpiece according to the second feed rate.

2. The electrical discharge machining equipment with equal-energy density of claim 1, further comprising an analysis unit connected to the processing parameter database, and the processing parameter database being configured to store a plurality of historical processing parameters, the analysis unit being configured to analyze the plurality of historical processing parameters to generate the equal-energy density sheet with a regression analysis.

3. The electrical discharge machining equipment with equal-energy density of claim 2, wherein the historical processing parameters comprise at least one of a normal discharge frequency, an arc discharge frequency, a short-circuit discharge frequency, a processing time, a processing coordinate, a processing voltage, a processing current, a processing volume and an electrode feed rate.

4. The electrical discharge machining equipment with equal-energy density of claim 1, wherein the first discharge parameter is corresponding to a first discharge energy and the second discharge parameter is corresponding to a second discharge energy, and the controller calculates the material volume according to the first discharge energy, the second discharge energy, the material removed volume corresponding to the first discharge energy and the energy density.

5. An electrical discharge machining method with equal-energy density, comprising the following steps of:
an electrode processing a workpiece with a first discharge energy, a first discharge parameter and a first feed rate of a first processing parameter set;
a signal capturing device detecting that the first discharge parameter changes to a second discharge parameter;
a controller calculating a material volume of the workpiece according to the second discharge parameter and an equal-energy density sheet, wherein the equal-energy density sheet comprises a plurality of processing parameter sets, each of the processing parameter sets is corresponding to a material removed volume and comprises a discharge energy, a discharge parameter, a feed rate and an energy density, the energy density is generated according to a calculation of the discharge energy and the material removed volume, and the processing parameter sets have the same energy density; and
the controller selecting a second feed rate from a second processing parameter set according to the material volume, the material removed volume and the equal-energy density sheet and controlling the electrode to process the workpiece according to the second feed rate.

6. The electrical discharge machining method with equal-energy density of claim 5, further comprising the following steps of:
an analysis unit analyzing a plurality of historical processing parameters to generate the equal-energy density sheet with a regression analysis.

7. The electrical discharge machining method with equal-energy density of claim 6, wherein the historical processing parameters comprise at least one of a normal discharge frequency, an arc discharge frequency, a short-circuit discharge frequency, a processing time, a processing coordinate, a processing voltage, a processing current, a processing volume and an electrode feed rate.

8. The electrical discharge machining method with equal-energy density of claim 5, wherein the first discharge parameter is corresponding to a first discharge energy and the second discharge parameter is corresponding to a second discharge energy, and the step of the controller calculating the material volume of the workpiece according to the second discharge parameter and the equal-energy density sheet further comprises the following steps of:
the controller calculating the material volume according to the first discharge energy, the second discharge energy, the material removed volume corresponding to the first discharge energy and the energy density.

9. The electrical discharge machining method with equal-energy density of claim 5, further comprising the following steps of:
the electrode roughly cutting the workpiece.
